(19) United States
(12) Patent Application Publication
(10) Pub. No.: US 2026/0338145 A1
(43) Pub. Date: Oct. 29, 2026

(54) PRECHAMBER ASSEMBLY

(71) Applicant: INNIO Jenbacher GmbH & Co OG, Jenbach (AT)

(72) Inventors: Wolfgang Fimml, Maurach in Tirol (AT); Guenther Waldner, Achenkirch (AT)

(21) Appl. No.: 19/675,709

(22) Filed: May 13, 2026

Related U.S. Application Data
(63) Continuation of application No. 18/850,532, filed on Mar. 24, 2022, now Pat. No. 12,650,107.

(51) Int. Cl. F02M 55/00; F02B 19/12; F02B 19/16

(52) U.S. Cl. CPC F02M 55/004; F02B 19/12; F02B 19/16

(57) ABSTRACT

A prechamber assembly for an internal combustion engine in which a sealing seat is formed between at least one first sleeve seat surface (12) of a prechamber sleeve (1) and at least one injector seat surface (11) of at least one fuel injector (4).

### CROSS-REFERENCE TO RELATED APPLICATIONS

This application is continuation of US Application No. 18/850,532, filed Sep. 24, 2024, entitled “PRECHAMBER ASSEMBLY”, which is a National Stage entry from, and claims benefit of, PCT Application No. PCT/AT2022/060092, filed on Mar. 24, 2022, entitled “PRECHAMBER ASSEMBLY”, which is herein incorporated by reference in its entirety.

### BACKGROUND

The invention is in the field of a prechamber assembly for an internal combustion engine.

WO 2020 158 263 Al shows a prechamber used to ignite an air-fuel mixture in a main combustion chamber. In order to reduce the emissions of the internal combustion engine during engine start, a prechamber heating operations is performed by injecting a predetermined amount of fuel into the prechamber by way of a fuel injector and igniting an air-fuel-mixture therein using a spark plug, while a main fuel injector is deactivated during at least a first engine cycle after engine start request.

It is problematic to achieve sufficient sealing of the prechamber arrangement, especially if there are concerns with space requirement, in particular, if it is intended to provide all the fuel necessary for the working of the internal combustion engine via the prechamber assembly.

### BRIEF DESCRIPTION

It is an aspect of certain embodiments of the invention to provide a prechamber assembly for an internal combustion engine with improved sealing such that the prechamber assembly has reduced space requirement.

Still other aspects and advantages of certain embodiments of the invention will in part be apparent from the specification and drawings.

One aspect of the disclosure relates to a prechamber assembly for an internal combustion engine, comprising:
an elongated prechamber sleeve having
an axis of elongation
at least one first opening for partially inserting at least one fuel injector, for injection of hydrogen, the at least one first opening being surrounded by at least one first sleeve seat surface
at least one second opening for at least one ignition device
preferably, a third opening for contacting a riser channel
at least one prechamber volume connected to the aforementioned openings
at least one fuel injector for injecting fuel into the at least one prechamber volume, the at least one fuel injector being arranged at least substantially parallel (preferably parallel) to the axis of elongation and having at least one injector seat surface
at least one ignition device for igniting a fuel-air-mixture inside the at least one prechamber volume, the at least one ignition device protruding into the at least one second opening and having an elongated shape and a device axis which forms an acute angle with the axis of elongation (preferably in a range of 30° to 90° measured from the device axis)
wherein a sealing seat is formed between the at least one first sleeve seat surface and the at least one injector seat surface

Because the at least one fuel injector is arranged at least substantially parallel to the axis of elongation and has at least one injector seat surface and the prechamber sleeve has at least one corresponding first sleeve seat surface, it is possible to achieve sealing between the at least one fuel injector and the prechamber sleeve by applying pressure along the axis of elongation on the at least one fuel injector. This pressure can be applied when the at least one fuel injector is mounted to the cylinder head, such that the at least one injector seat surface presses against the at least one first sleeve seat surface. In this way, a metallic sealing edge is formed between the at least one fuel injector and the prechamber sleeve.

The arrangement of the at least one fuel injector at least substantially parallel, and preferably parallel, to the axis of elongation leaves more space compared to the prior art and allows the use of a fuel injector by which all the fuel necessary for the working of the internal combustion engine can be provided via the prechamber assembly.

In case the prechamber sleeve is of substantially cylindrical shape (with circular or elliptical cross-section), then the axis of elongation is the cylinder axis.

It should be noted that the at least one second opening of the prechamber sleeve provides enough clearance for the at least one injection device not to hinder the slight movements of the parts in connection with the appliance of the pressure via the at least one fuel injector.

Preferred embodiments of the invention are described in dependent claims.

It is possible that the prechamber sleeve comprises a prechamber which also encompasses a riser channel.

It is possible that the at least one fuel injector and the prechamber sleeve are braced against each other.

In a preferred embodiment, the prechamber assembly comprises a riser channel sleeve in which at least one riser channel is arranged, the riser channel sleeve having at least one first channel seat surface and the at least one third opening having at least one second sleeve seat surface, wherein a (metallic) sealing seat is formed between the at least one first channel seat surface and the at least one second sleeve seat surface. Due to the at least one fuel injector being mounted to the cylinder head, the at least one second sleeve seat surface presses against the at least one first channel seat surface.

In a preferred embodiment, the at least one second opening has at least one third sleeve seat surface and the at least one ignition device has at least one igniter seat surface, wherein a sealing seat is formed between the at least one igniter seat surface and the at least one third sleeve seat surface (front- sealed ignition device). This arrangement needs less space than the standard sealing arrangement using a seal arranged farther away from the prechamber sleeve (in case a spark plug is used, usually on the far side of the spark plug thread).

In these embodiments, it is preferred that the at least one ignition device comprises a spark plug arranged in a spark plug sleeve and the at least one igniter seat surface is arranged on the spark plug sleeve.

Alternatively, or in addition, it can also be provided in these embodiments that the front-sealed ignition device can be fastened (preferably screwed) laterally into the prechamber sleeve. It might be advantageous to strengthen the prechamber in this region in direction towards the prechamber volume, such that a wall strength of the prechamber sleeve is increased with respect to other regions.

It is preferred, that a middle of a front surface of the at least one ignition device is positioned in a distance of about 0 - 50%, preferably of about 10 - 35% of a diameter of the at least one ignition device in front of an axis of elongation of the at least one fuel injector (measured in a direction orthogonal to the axis of elongation of the at least one fuel injector).

In a preferred embodiment, there is only one fuel injector present in the prechamber assembly.

In some embodiments, fuel can be injected by the at least one fuel injector with a pressure between 30 bar and 50 bar.

In a preferred embodiment of the prechamber assembly, the following sealing seats are formed when an axial force is exerted onto the at least one fuel injector during mounting of the at least one fuel injector to the at least one cylinder head surface:
between the at least one fuel injector and the prechamber sleeve (between the at least one first sleeve seat surface and the at least one injector seat surface)
between the riser channel sleeve and the prechamber sleeve (between the at least one first channel seat surface and the at least one second sleeve seat surface)
between the at least one ignition device and the prechamber sleeve (between the at least one igniter seat surface and the at least one third sleeve seat surface)

In some embodiments, it is provided that
the at least one first opening is arranged on a front surface, and/ or
the at least one second opening is arranged on a lateral surface, and/or
the at least one third opening is arranged on a front surface of the elongated prechamber sleeve

In some embodiments, it is provided that the prechamber volume has, along the axis of elongation, a first cross section and a second cross section of different sizes, the cross section of larger size being arranged at the height of the at least one ignition device. The reason for this is to achieve a lower flow velocity of the injected fuel in the region of the at least one ignition device.

In these embodiments, it is preferred that a diameter of the prechamber volume is larger at an ignition gap (in particular, or electrode gap) of the at least one ignition device (in particular, a spark gap of a spark plug) than a diameter of the prechamber at the point of injection of the at least one fuel injector. In this way, the flow rate of the fuel injected by the at least one fuel injector is reduced at the ignition gap.

Although the prechamber assembly according to certain embodiments of the invention can be used with any type of engine, it is preferred that it is used in an internal combustion engine having at least one piston-cylinder-unit, preferably at least 10 piston- cylinder-units.

Although the prechamber assembly according to certain embodiments of the invention can be used with any type of engine, it is preferred that it is used in an internal combustion engine that can be coupled with an electric generator to form a genset for the production of electric energy.

Although the prechamber assembly according to certain embodiments of the invention can be used with any type of engine, it is preferred that it is used in a stationary internal combustion engine.

It is to be understood that the features of the preceding paragraphs can be used in isolation or combined in any way.

### BRIEF DESCRIPTION OF THE DRAWINGS

Embodiments of the invention are discussed making use of the enclosed figures.

FIG. 1 shows a cut section drawing along a medial plane of the prechamber assembly in a state mounted to a cylinder head of an internal combustion engine.

FIG. 2 shows a detail of FIG. 1 in an enlarged presentation.

FIG. 3 shows a prechamber sleeve of a prechamber assembly of FIG. 1.

FIG. 4 shows a view along the axis of elongation of the prechamber assembly of FIG. 1 viewed from a main combustion chamber of the internal combustion engine.

### DETAILED DESCRIPTION

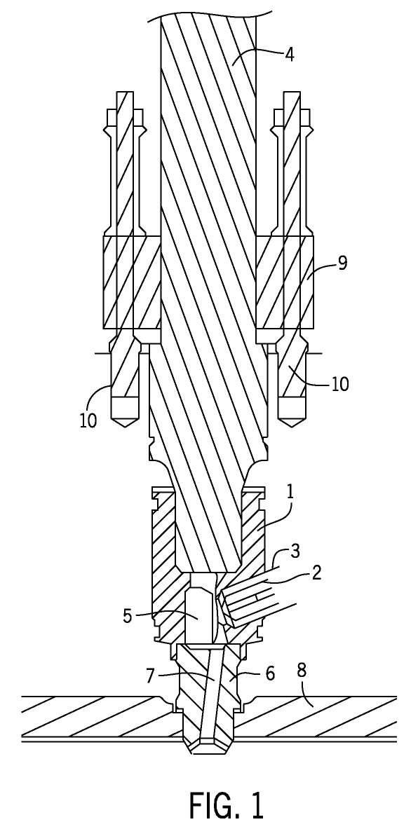

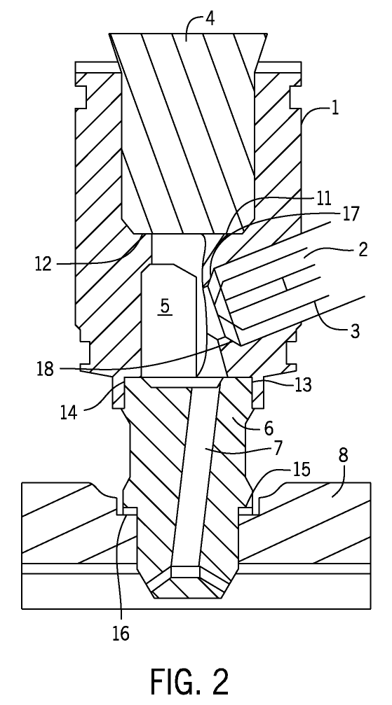

In FIG. 1, it is shown that the fuel injector 4 is mounted, in this example by way of bolts 10, to the cylinder head 8. It is important that the fuel injector 4 is pressed by the bolts 10 against the cylinder head 8. Due to this force, a seal is achieved (cf. FIG. 2):
between the fuel injector 4 and the prechamber sleeve 1 (between the first sleeve seat surface 12 and the at least one injector seat surface 11)
between the riser channel sleeve 6 and the prechamber sleeve 1 (between the at least one first channel seat surface 13 and the at least one second sleeve seat surface 14)
between the at least one ignition device and the prechamber sleeve 1 (between the at least one igniter seat surface 17 and the at least one third sleeve seat surface 18)

It should be noted that the sealing ring visible on a lateral surface of the prechamber sleeve 1 is not necessary to achieve sealing, but the sealing ring is used only to stabilize the prechamber sleeve 1 during assembly. The seal is achieved by metallic contact on the front surfaces of the parts.

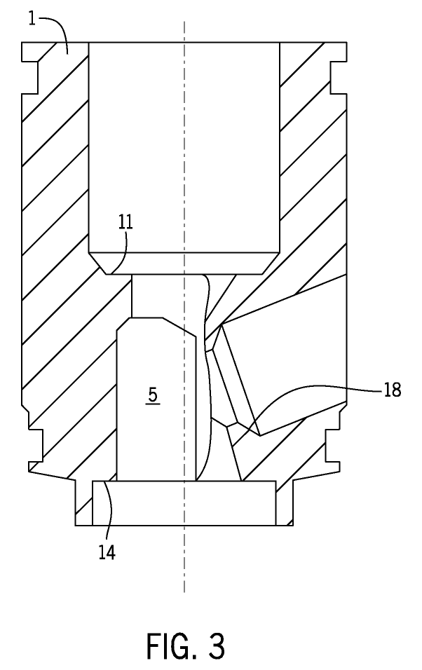

FIG. 3 shows the prechamber sleeve 1 in isolation.

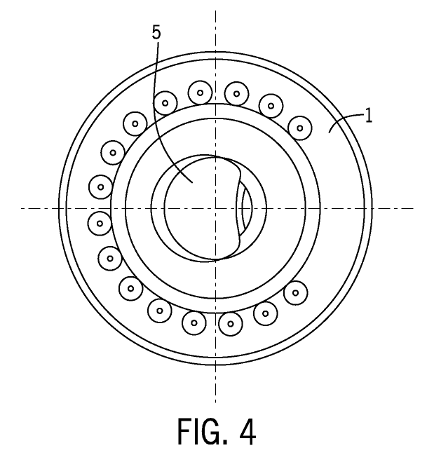

In FIG. 4, the openings of the riser channel 7 into a main combustion chamber can be seen.

### LIST OF REFERENCE

1 prechamber sleeve
2 spark plug
3 spark plug sleeve
4 fuel injector
5 prechamber volume
6 riser channel sleeve
7 riser channel
8 cylinder head
9 mounting sleeve
10 bolt
11 injector seat surface
12 first sleeve seat surface
13 first channel seat surface
14 second sleeve seat surface
15 second channel seat surface
16 cylinder head surface
17 igniter seat surface
18 third sleeve seat surface

1. A system, comprising:
a prechamber assembly configured to couple to an internal combustion engine, wherein the prechamber assembly comprises:
a prechamber body, comprising:
a central axis;
a sidewall extending circumferentially about the central axis;
a first opening in a first axial end portion of the prechamber body, wherein the first opening is coaxial with the central axis, and the first opening is configured to mount a fuel injector coaxial with the central axis; and
a second opening in the sidewall, wherein the second opening is configured to mount an igniter laterally into the sidewall.

2. The system of claim 1, wherein the prechamber body comprises a prechamber sleeve having a cylindrical shape, and the central axis is a cylinder axis of the cylindrical shape.

3. The system of claim 1, wherein the prechamber body forms a prechamber volume asymmetric relative to the central axis.

4. The system of claim 3, wherein an inner surface of the sidewall forms the prechamber volume, and the inner surface varies in a radial distance from the central axis in a circumferential direction around the central axis.

5. The system of claim 4, wherein the sidewall varies in radial thickness in the circumferential direction around the central axis.

6. The system of claim 4, wherein the inner surface varies in the radial distance between first and second radial distances at opposite first and second sides of the sidewall, the first radial distance is less than the second radial distance, and the second opening is disposed in the first side of the sidewall.

7. The system of claim 4, wherein the prechamber volume has a first cross-sectional area adjacent the first opening, and a second cross-sectional area adjacent the second opening, and the second cross-sectional area is less than the first cross-sectional area.

8. The system of claim 7, wherein the prechamber volume has a third cross-sectional area adjacent a second axial end portion of the prechamber body, and the second cross-sectional area is less than the third cross-sectional area.

9. The system of claim 1, wherein the second opening is disposed between the first axial end portion and an opposite second axial end portion of the prechamber body, and the second opening is axially offset from the first opening by an axial offset distance.

10. The system of claim 1, wherein the prechamber assembly comprises a riser body coupled to a second axial end portion of the prechamber body.

11. The system of claim 10, wherein the riser body comprises a riser channel sleeve oriented at an angle relative to the central axis, and the angle is oriented in a direction extending both axially and radially away from the second opening.

12. The system of claim 10, wherein the prechamber body comprises a third opening in the second axial end portion of the prechamber body, and the riser body mounts into the third opening.

13. A system, comprising:
a prechamber assembly configured to couple to an internal combustion engine, wherein the prechamber assembly comprises:
a prechamber body, comprising:
a central axis;
a sidewall extending circumferentially about the central axis; and
a first opening in a first axial end portion of the prechamber body, wherein the first opening is coaxial with the central axis, and the first opening is configured to mount a fuel injector coaxial with the central axis.

14. The system of claim 13, wherein the prechamber body forms a prechamber volume asymmetric relative to the central axis.

15. The system of claim 14, wherein an inner surface of the sidewall forms the prechamber volume, and the inner surface varies in a radial distance from the central axis in a circumferential direction around the central axis.

16. The system of claim 15, wherein the prechamber volume has a first cross-sectional area adjacent the first opening, a second cross-sectional area in an intermediate position between the first axial end portion and an opposite second axial end portion of the prechamber body, and a third cross-sectional area adjacent the second axial end portion, wherein the second cross-sectional area is less than the first and second cross-sectional areas.

17. The system of claim 16, wherein the prechamber body comprises a second opening in the sidewall, wherein the second opening is configured to mount an igniter laterally into the sidewall.

18. A system, comprising:
a prechamber assembly configured to couple to an internal combustion engine, wherein the prechamber assembly comprises:
a prechamber body, comprising:
a central axis;
a sidewall extending circumferentially about the central axis;
a first opening in the prechamber body, wherein the first opening is configured to mount a fuel injector; and
a second opening in the sidewall, wherein the second opening is configured to mount an igniter laterally into the sidewall.

19. The system of claim 18, wherein an inner surfacer of the prechamber body forms a prechamber volume asymmetric relative to the central axis, the inner surface varies in a radial distance from the central axis in a circumferential direction around the central axis, the inner surface varies in the radial distance between first and second radial distances at opposite first and second sides of the sidewall, the first radial distance is less than the second radial distance, and the second opening is disposed in the first side of the sidewall.

20. The system of claim 19, wherein the prechamber volume has a first cross-sectional area adjacent a first axial end portion of the prechamber body, a second cross-sectional area in an intermediate position between the first axial end portion and an opposite second axial end portion of the prechamber body, and a third cross-sectional area adjacent the second axial end portion, wherein the second cross-sectional area is less than the first and second cross-sectional areas, wherein the first opening is disposed at the first axial end portion of the prechamber body, wherein the second opening is disposed in the sidewall at the intermediate position.
